(19) United States
(12) Patent Application Publication
(10) Pub. No.: US 2026/0147011 A1
(43) Pub. Date: May 28, 2026

(54) Method for Determining a Rotor Angular Velocity

(71) Applicant: Robert Bosch GmbH, Stuttgart (DE)

(72) Inventors: Friedrich Braun, Boebingen (DE); Michael Deutsch, Lorch (DE)

(21) Appl. No.: 19/398,410

(22) Filed: Nov. 24, 2025

(30) Foreign Application Priority Data
Nov. 26, 2024 (DE) 10 2024 211 287.9

(51) Int. Cl. G01P 3/44; G01B 7/30

(52) U.S. Cl. CPC G01P 3/44; G01B 7/30

(57) ABSTRACT

A method for determining the rotor angular velocity of a motor of a power steering system in a vehicle is disclosed. According to the method, data is collected representing information about the rotor angular velocity, the data is filtered with a filter so that filtered data is obtained, and the filtered data is analyzed to determine the rotor angular velocity.

This application claims priority under 35 U.S.C. § 119 to patent application no. DE 10 2024 211 287.9, filed on Nov. 26, 2024 in Germany, the disclosure of which is incorporated herein by reference in its entirety.

The disclosure relates to a method for determining a rotor angular velocity of a motor of a power steering system motor in a vehicle, particularly in a motor vehicle, and an arrangement for performing the method.

### BACKGROUND

An electric power steering (EPS) system is used to reduce the force required to operate the steering wheel of a motor vehicle when steering it while sitting still, during maneuvering, or at low travel speeds. The power steering system assists the driver in steering by increasing the force applied by the driver for steering by way of a hydraulic system or a motor, in particular an electric motor.

In power steering systems, a so-called steering control unit (SCU), a control unit with an electric motor, is regularly used that supports all driver assistance functions and, if necessary, also functions for autonomous driving.

Such steering control units generally particularly comprise a magnetic rotor position sensor (RPS), comprising a permanent magnet and a detector for sensing a magnetic field, in order to measure the rotor angle and/or the rotor position, in particular the rotor angular velocity, of the motor, wherein the motor controls and/or drives the steering rack of a classical power steering system, or the actuators of a steer-by-wire steering system, the steering rack actuator (SRA) and the steering wheel actuator (SWA).

A certain immunity to magnetic field interference is required for safe operation of the steering system. This interference immunity may be checked for electromagnetic compatibility (EMC) as part of the product validation. Such validation may be performed to verify safe operation and also to verify driver comfort, whereby a check is performed to see whether such is disrupted.

Magnetic interference affecting an SCU may be caused, for example, by a wiring harness that supplies high power electrical vehicle applications and runs near the EPS ECU. The magnetic field of a high current flowing through the wiring harness may affect or interfere with a magnetic rotor position measurement system. Since the rotor position is an essential parameter for motor control, any static or alternating interference of the rotor position measurement, particularly the rotor angular velocity measurement, may affect motor actuation. This leads to negative effects on comfort, such as audible and perceivable vibrations (NVH: noise, vibration, harshness), which can affect drivers and passengers, even if safe operation of the vehicle is ensured.

Known methods for reducing the magnetic interference of a rotor position measurement system are, for example, implementations of mechanical, magnetic shielding elements around the rotor position measurement system. Disadvantages of this are additional costs for the mechanical, magnetic shielding elements and the fastening of the shielding elements within the control unit, in particular also magnetic remanence effects of the shielding elements in right-hand and left-hand motors, which adversely affect the accuracy of the rotor position measurement. Additional disadvantages are increased package size of the control unit and reduced potential for integration into vehicle architectures, and reduced potential for reuse of an existing control unit.

Another known approach provides for the use of alternative magnetic sensors with integrated interference compensation. This has the disadvantage that interference-compensated rotor position sensors are more expensive than standard TMR sensors. Furthermore, they require a higher level of peripheral electrical circuitry, which leads to additional cost and requires a larger printed circuit board surface.

### SUMMARY

Given this background, a method and a control unit are presented in the description set forth below. Embodiments arise from the from the description set forth below.

The method presented serves to determine the rotor angular velocity of a motor of a power steering system in a vehicle, in particular a motor vehicle. In the method, data provided or collected by a rotor position sensor, for example, is used, wherein the data represents information on the rotor position, in particular the rotor angular velocity. The acquired data is filtered with a filter so that filtered data is obtained, which in turn is analyzed to determine the rotor position, in particular the rotor angular velocity. The motor in particular can then be controlled with the determined rotor angular velocity.

With the method presented, the satisfaction of the customer with power steering systems can be increased, in particular if magnetic field interference is present, which is caused, for example, by high-current vehicle loads, such as eDrives, electrical stabilizers, heating systems and boost recuperation modules and associated wiring harnesses that run in the vicinity of the SCU.

The method presented allows the NVH effects caused by magnetic interference of a rotor position measurement system in a power steering system to be reduced. The interference of the rotor position measurement system may be caused, for example, by an external static or alternating magnetic field near the SCU and by interference of the rotor position measurement system, which consists of a permanent magnet attached to the motor shaft and, for example, a TMR sensor.

The method presented thus proposes to apply filter software to the rotor position measurement data, in particular the rotor angular velocity, which reduces the effect caused by the disruptive external magnetic fields.

An embodiment of the method is presented that applies a software filter to the rotor position measurement data and the calculated rotor angular velocity in the motor control software, in order to reduce the influence of a disrupted rotor position angle measurement, particularly in the critical frequency range of 100 to 1000 Hz, thereby improving performance with respect to NVH, by reducing NVH effects caused by interference from an external magnetic field.

The method typically uses a software filter, that is, it uses software that performs the filtering.

Rotor position measurement data and derived rotor position velocity data can be filtered as data.

In a further embodiment, the filter is configured to filter within a frequency range from 100 to 1000 Hz.

A notch filter may be used as the filter. A notch filter, also referred to as a band rejection filter or a blocking filter, is a filter configured to pass signals above and below a particular frequency band in as unchanged a manner as possible. Frequencies can thus be filtered out within a narrow frequency range. Viewed graphically, a notch is consequently inserted into the frequency diagram.

Furthermore, an adjustable filter can be used. There is good adaptability with a software solution, for example.

The presented control unit is used to perform the method described herein and has a filter and an analysis unit for this purpose. The filter and/or the analysis unit may be implemented by way of hardware or software. Typically, the control unit is provided in a steering control unit.

Advantages of the presented solution with the filter software are:
There is no noticeable impact on the steering feel with software with a blocking filter or notch filter that is applied to the rotor position angular velocity data.

The software filter characteristics are configurable to adapt this software filter for the intended use, e.g. by balancing the steering feel and the NVH performance.

No additional mechanical shielding against external magnetic fields is required. Therefore, no additional costs for mechanical and electronic devices are incurred. Furthermore, there is no increased pack size due to an inclusion of additional mechanical shield elements.

Reuse of a standard rotor position measurement system is possible. As a result, no budget is needed for the development and qualification of a new hardware rotor position measurement system. Therefore, hardware costs do not increase. A risk associated with the development of an alternative, more robust rotor position measurement solution is avoided.

Further advantages and embodiments of the disclosure are shown in the description and the accompanying drawings.

It is understood that the abovementioned features and those to be explained below can be used not only in the combination indicated in each case, but also in other combinations or on their own, without departing from the scope of the present disclosure.

### BRIEF DESCRIPTION OF THE DRAWINGS

FIG. 1 shows a graph of the performance potential of EPS systems versus magnetic interference.

FIG. 2 shows a graph of filter properties for rotor position measurement data and associated NVH performance in the target.

FIG. 3 shows, with the aid of a graph, the performance increase due to rotor position filtering software.

FIG. 4 shows a flowchart of a possible sequence of the presented method.

FIG. 5 shows a highly simplified, purely schematic representation of a vehicle with an embodiment of the described arrangement for carrying out the method.

### DETAILED DESCRIPTION

The disclosure is illustrated schematically by way of embodiments in the drawings and is described in detail below with reference to the drawings.

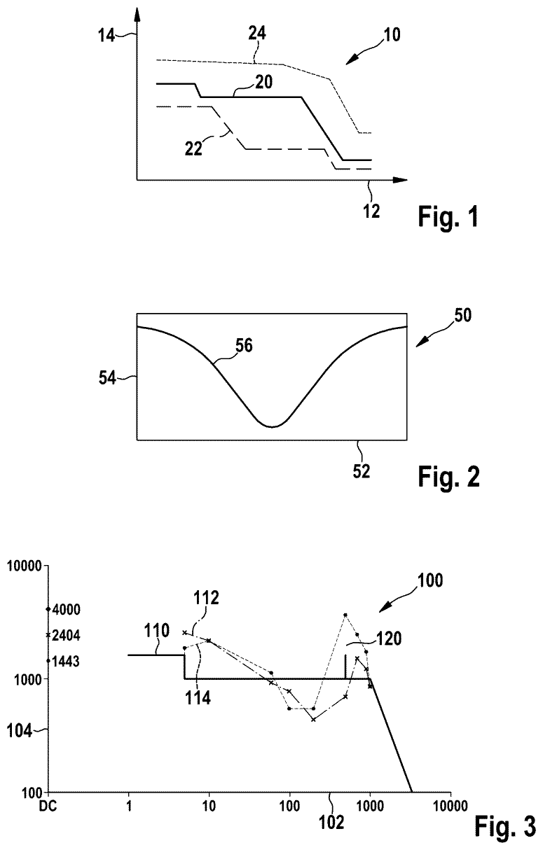

FIG. 1 shows a curve (envelope) and an evaluation result in a graph 10, whereby the frequency [Hz] is shown on the abscissa 12 and the magnetic field strength [A/m] is shown on the ordinate 14.

Graph 10 may be used to determine whether unacceptable NVH phenomena occur. For this purpose, the performance potential is compared with the required magnetic field test level for an EMC product validation. The solid-line curve 20 and dashed-line curve 22 indicate customer envelopes for magnetic test severity levels and the dotted-line curve 24 indicates the NVH performance potential for different SCU generations.

Whenever the NVH performance potential 24, the maximum magnetic field without NVH, is below the magnetic field test level for product validation represented by curves 20 and 22, the EPS system will not meet the comfort performance requirements in the vehicle with the presence of required interference levels for an EMC qualification.

FIG. 2 shows filter properties for RPS measurement data and associated rotor velocity for the NVH performance in the target range in a graph 50, whereby the frequency is shown on the abscissa 52 and the attenuation is shown on the ordinate 54.

The illustration shows a filter curve 56 for attenuating the rotor velocity. The filter properties, i.e. frequency and attenuation, are derived from FIG. 1.

Since the motor control software considers the first derivative of the RPS angle measurement with respect to time (dφ/dt), an associated filtering function was generated and applied to the calculated motor angle velocity.

FIG. 3 shows the NVH performance potential achieved with the applied filter software on and off in specific EPS software. The illustration shows a graph 100 with frequency [Hz] shown on the abscissa 102 and the magnetic field strength [A/m] shown on the ordinate 104. The illustration shows an envelope for a required magnetic interference level 110 and two curves 112 and 114 for the NVH potential.

There are some frequency bands in the graphs shown in FIG. 3 where the measurements with a first blocking filter do not yet provide the required characteristics, but this is a matter of filter configuration. The first results clearly show the desired improvement in the most critical frequency range marked with reference number 120.

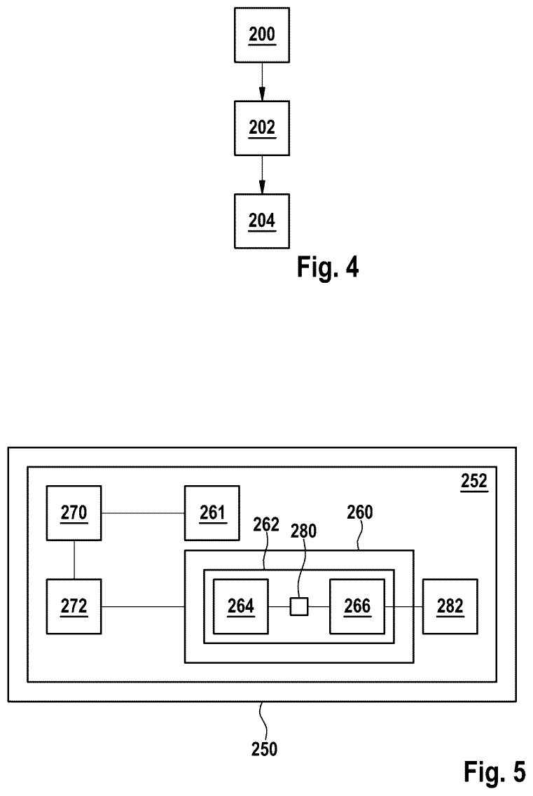

FIG. 4 shows a flowchart of a possible, highly simplified sequence of the presented method. In a first step 200, data from a rotor position sensor is collected. In a further step 202, the rotor angular velocity is calculated with this data, which is filtered by way of the presented notch filter. The filtered data is finally analyzed in a step 204 to obtain rotor position information.

FIG. 5 shows a purely schematic highly simplified representation of a vehicle, which is labeled with the reference number 250. This vehicle 250 comprises a steering control unit 252, which in turn comprises a control unit 260 and a motor 261. A computing unit 262 is provided in the control unit 260, on which software is executed that includes a filter 264 and an analysis unit 266.

The motor 261 is associated with a rotor position sensor 270 that provides rotor position data 272, which is made available to the control unit and thus the computing unit 262. This data 272 is first filtered with the filter 264 so that filtered data 280 is obtained, which is then analyzed with the analysis unit 266 to indicate the rotor position, and in particular the rotor angular velocity 282, in a manner that is as free from interference as possible.

What is claimed is:

1. A method for determining rotor angular velocity of a motor of a power steering system in a vehicle, comprising:
collecting data representing information about the rotor angular velocity;
filtering the collected data with a filter so that filtered data is obtained; and
analyzing the filtered data to determine the rotor angular velocity.

2. The method according to claim 1, further comprising using the determined rotor angular velocity to control the motor.

3. The method according to claim 1, wherein a software filter is used.

4. The method according to claim 1, wherein the filter is configured to filter in a frequency range of 100 to 1000 Hz.

5. The method according to claim 1, wherein a notch filter is used.

6. The method according to claim 1, wherein an adjustable filter is used.

7. The method according to claim 1, wherein the data is provided by a rotor position sensor.

8. A control unit for determining the rotor angular velocity of a motor of a power steering system in a vehicle comprising a computing unit configured to perform the method according to claim 1.

9. The control unit according to claim 8, wherein the computing unit comprises a filter and an analysis unit.

10. The control unit according to claim 9, wherein the filter and/or the analysis unit are implemented by way of or consist of software.
